(19) United States
(12) Patent Application Publication
(10) Pub. No.: US 2023/0094138 A1
(43) Pub. Date: Mar. 30, 2023

(54) CAPSULE BEVERAGE EXTRACTION DEVICE AND METHOD FOR CONTROLLING SAME

(71) Applicant: MEDIPRESSO, Daejeon (KR)

(72) Inventor: Haseob KIM, Osan-si, Gyeonggi-do (KR)

(73) Assignee: MEDIPRESSO, Daejeon (KR)

(21) Appl. No.: 16/971,685

(22) PCT Filed: Jan. 13, 2020
(86) PCT No.: PCT/KR2020/000576

§ 371 Date: Aug. 21, 2020

(30) Foreign Application Priority Data
Oct. 21, 2019 (KR) 10-2019-0130470
Oct. 21, 2019 (KR) 10-2019-0130477
Nov. 19, 2019 (KR) 10-2019-0148949
Nov. 19, 2019 (KR) 10-2019-0148964
Nov. 19, 2019 (KR) 10-2019-0148974

(51) Int. Cl. A47J 31/36; A47J 31/46

(52) U.S. Cl. CPC A47J 31/3623; A47J 31/461

(57) ABSTRACT

The present invention relates to a capsule beverage extraction device for extracting a beverage using a capsule including powder, the device being characterized by including: a pump for supplying room temperature water; a boiler configured to heat the room temperature water supplied from the pump and convert the room temperature water into hot water; a first extracting part for supplying hot water to a capsule and extract the beverage; a second extracting part provided beside the first extracting part and configured to supply hot water to the capsule and extract the beverage; a first flow passage for supplying hot water to the first extracting part from the boiler; a first valve for selectively opening/closing the first flow passage; a second flow passage for supplying from the boiler to the second extracting part; and a second valve for selectively opening/closing the second flow passage.

### TECHNICAL FIELD

The present invention relates to a capsule beverage extraction device and a method for controlling the same.

### BACKGROUND ART

In general, in capsule beverage extraction devices for obtaining tea or espresso, a capsule containing powder tea or powder coffee is mounted to a holder of an extraction part, the capsule mounted on the holder is then punched by a punching part to make holes, and a beverage is extracted using a method of adding hot water to the punched capsule.

Such capsule beverage extraction devices have been gradually spread because tea or espresso can be easily obtained at home or office.

However, in typical arts, a beverage can be extracted after a user presses a boiler heating button of a capsule beverage extraction device and waits for a predetermined time (approximately 30 seconds), and therefore there was a problem in that it took somewhat long time until a user obtained a beverage.

Furthermore, when there is no water, a waste capsule tray is fully filled, or there is no new capsule, there is also a constant problem in that a user cannot easily extract a beverage immediately.

In addition, in typical extraction devices, only one among tea and coffee should be selected and extracted during one extraction, and therefore various types of beverage cannot be extracted at once, and thus, when there are many users, there is inconvenience of long waiting.

Furthermore, in case of tea and coffee, flavor is one of the most influencing factors to palatability, and typical extraction devices have problems in that when tea and coffee are alternately extracted, the flavor of coffee permeates into the tea in extraction or the flavor of tea permeates into the coffee in extraction.

In addition, in typical extraction devices, the height of a nozzle is fixed and there is no problem when using a large-size cup, but when a small-size cup is used, there is also a problem in that dropped extract rebounds from the bottom of the cup and splashes to the surrounding.

Finally, in typical arts, since a method of storing a new capsule before use in a separate holder is generally used, there are problems in that space availability is low, a user should immediately remove a capsule after use, and the remaining water of the capsule flows to the surrounding in the process and spoils cleanliness and beauty.

### DISCLOSURE OF THE INVENTION

### Technical Problem

The present invention is derived to solve the above limitations, and a purpose of the present invention is to simultaneously extracting two or more beverages with a single extraction device.

More specifically, a purpose of the present invention is to prevent flavors from mixing when simultaneously extracting two cups of beverage.

More specifically, a purpose of the present invention is to optimize the arrangement of required components for simultaneously extracting two cups of beverage and enhancing space availability.

Another purpose of the present invention is to prevent extracted beverage jetted from a nozzle from rebounding from the bottom of a cup and flowing out of the cup regardless of the height of the cup.

Another purpose of the present invention is to store, in an extraction device, a new capsule for extracting a beverage by efficiently disposing each of configurations.

Another purpose of the present invention is to store, in an extraction device, a new capsule for extracting a beverage by efficiently disposing each of configurations.

A purpose of the present invention is to store a completely used waste capsule by efficiently using a space of an extraction device, and guaranteeing cleanliness and convenience in a process of drawing the stored waste capsule out of an extraction device.

The present invention is derived to solve the above limitations and a purpose of the present invention is to reduce a waiting time of a user due to boiler preheating.

In addition, a purpose of the present invention is to request water supply before a user extracts a beverage when a water container is vacant.

In addition, a purpose of the present invention is to request waste capsule collection before a user extracts a beverage when a waste capsule tray is fully filled.

In addition, a purpose of the present invention is to request capsule refill before a user extracts a beverage when a capsule storage box is vacant.

### Technical Solution

According to an embodiment of the present invention, a capsule beverage extraction device for extracting a beverage using a capsule containing powder may be provided, the device including: a pump for supplying room temperature water; a boiler configured to heat the room temperature water supplied from the pump and convert the room temperature water into hot water; a first extracting part for supplying hot water to the capsule and extract the beverage; a second extracting part provided beside the first extracting part and configured to supply hot water to the capsule and extract the beverage; a first flow passage for supplying hot water to the first extracting part from the boiler; a first valve for selectively opening/closing the first flow passage; a second flow passage for supplying from the boiler to the second extracting part; and a second valve for selectively opening/closing the second flow passage.

In an exemplary embodiment, the first extracting part may include a first extracting part frame configured to store a capsule holder for holding the capsule and supplying hot water to the capsule, the second extracting part may include a second extracting part frame provided side by side with the first extracting part frame and configured to store a capsule holder for to holding a capsule and supplying hot water to the capsule, wherein one side surface of the first extracting part frame may be formed as a closed surface, and one side surface of the second extracting part frame in the first extracting part direction directing the one side surface of the first extracting part frame may be formed as a closed surface.

In an exemplary embodiment, the capsule beverage extraction device may further include: a housing constituting exterior appearance; and an inner frame provided inside the housing.

In an exemplary embodiment, the inner frame may include: a lower inner frame configured to store the pump and the boiler; and an upper frame to which the first extracting part and the second extracting part are fixed.

In an exemplary embodiment, the capsule beverage extraction device may further include: a first waste capsule collecting part provided below the first extracting part and configured to store a waste capsule from which the beverage has been completely extracted in the first extracting part; and a second waste capsule collecting part provided below the second extracting part and configured to store a waste capsule from which the beverage has been completely extracted in the second extracting part, wherein the first waste capsule collecting part and the second waste capsule collecting part may be respectively provided on both sides of the lower inner frame.

In an exemplary embodiment, the capsule beverage extraction device may further include: a water container for supplying room temperature water to the pump, wherein the water container may be provided between the first waste capsule collecting part and the second waste capsule collecting part and be positioned in rear of the pump and the boiler.

In an exemplary embodiment, the capsule beverage extraction device may further include a capsule storing box fixed to the inner frame and configured to store the capsule before use, wherein the capsule storing box may be provided between the first extracting part and the second extracting part.

In an exemplary embodiment, the capsule beverage extraction device may further include a capsule storing box cover provided on an upper surface of the housing and provided so as to selectively open/close the capsule storing box.

In an exemplary embodiment, the first valve and the second valve may be stored inside the lower inner frame.

In an exemplary embodiment, the capsule beverage extraction device may further include: a first nozzle configured to guide, to the outside, the beverage extracted from the first extracting part; and a second nozzle configured to guide, to the outside, the beverage extracted from the second extracting part, wherein the first nozzle and the second nozzle may be provided so as to have adjustable heights.

In an exemplary embodiment, the capsule beverage extraction device may further include: a first nozzle moving handle connected to the first nozzle; and a second nozzle moving handle connected to the second nozzle.

In an exemplary embodiment, the capsule beverage extraction device may further include: a tray module including; a tray provided below the first nozzle and the second nozzle; and a remaining water support part provided so as to support the tray, wherein the tray may be supported by the remaining water support part so that a rear end of the tray inclines rearward by a predetermined angle.

In an exemplary embodiment, the capsule beverage extraction device may further include a front panel provided on a front surface of the housing and configured to support a rear surface of a cup placed on the tray, wherein the front panel may include: a first panel provided so as to be bent rearward; and a second panel provided on a side surface of the first panel and provided so as to be bent rearward.

According to an embodiment of the present invention, a capsule beverage extraction device, for extracting a beverage using a capsule containing powder, may be provided, the device including: a first extracting part configured to supply hot water to the capsule and extract the beverage; a second extracting part configured to supply hot water to the capsule and extract the beverage; a first nozzle configured to guide to the outside the beverage extracted from the first extracting part; and a second nozzle configured to guide the beverage extracted from the second extracting part, wherein the first nozzle and the second nozzle are provided to have adjustable heights.

According to an embodiment of the present invention, a capsule beverage extraction device, for extracting a beverage using a capsule comprising powder, may be provided, the device including: a housing; an inner frame provided inside the housing; a first extracting part fixed to the inner frame and configured to supply hot water to the capsule and extract the beverage; a second extracting part fixed to the inner frame and configured to supply hot water to the capsule and extract the beverage; a capsule storing box fixed to the inner frame and configured to store the capsule before use; and a capsule storing box cover provided on an upper surface of the housing and provided so as to selectively open/close the capsule storing box, wherein the capsule storing box is provided between the first extracting part and the second extracting part.

According to an embodiment of the present invention, a beverage extraction device for extracting a beverage using a capsule containing powder may be provided, the device including: a housing configured to form an outer appearance and provided with a capsule input opening; an extracting part provided inside the housing and configured to supply hot water to extract the beverage; and a waste capsule collecting part stored inside the housing and configured to store a waste capsule from which the beverage has been completely extracted in the extracting part, wherein the waste capsule collecting part is provided below the extracting part and is provided to be selectively taken out to a rear side of the housing.

In an exemplary embodiment, the waste capsule collecting part may include: a basket storing part provided so as to rotate to a rear side of the housing around one side; and a basket stored in the basket storing part and configured to store the waste capsule from which the beverage has been completely extracted in the extracting part.

In an exemplary embodiment, the basket may be provided so as to be selectively removed from the basket storing part.

In an exemplary embodiment, the basket may be provided so as to be stored in or removed from the basket storing part via an upper surface of the basket storing part.

In an exemplary embodiment, the basket may include: a basket body for storing the waste capsule; and a basket handle provide on one side of the basket body.

In an exemplary embodiment, a basket hole may be formed in a lower end of the basket, and a remaining water stay space for storing remaining water discharged through the basket hole may be provided inside the basket storing part.

In an exemplary embodiment, the beverage extraction device may further include an inner frame provided inside the housing and having an upper side to which the extracting part is fixed, wherein the extracting part may include a capsule holder configured to hold the capsule and supply hot water into the capsule, a lower portion of the capsule holder in the inner frame may be open toward the waste capsule collecting part so that the waste capsule from which the beverage has been completely extracted is removed from the capsule holder and falls to the waste capsule collecting part.

In an exemplary embodiment, the beverage extraction device may further include an elastic part provided inside the housing and configured to supply an elastic force to the basket storing part in a direction toward the inside the housing.

In an exemplary embodiment, the beverage extraction device may further include a capsule storing box provided on s side surface of the extracting part and configured to store the capsule before use.

In an exemplary embodiment, the beverage extraction device may further include a capsule storing box cover provided on an upper surface of the housing and provided so as to selectively open/close the capsule storing box, and the capsule input opening may be provided on the upper surface of the housing.

In an exemplary embodiment, the beverage extraction device may further include a capsule input opening cover provided on the upper surface of the housing and provided so as to selectively open/close the capsule input opening.

In an exemplary embodiment, the beverage extraction device may further include: a first extracting part configured to supply hot water to the capsule and extract the beverage; a second extracting part provided beside the first extracting part and configured to supply hot water to the capsule to extract the beverage, wherein the waste capsule collecting part may further include a first waste capsule collecting part provided below the first extracting part and configured to store the waste capsule from which the beverage has been completely extracted in the first extracting part, and a second waste capsule collecting part provided below the second extracting part and configured to store the waste capsule from which the beverage has been completely extracted in the second extracting part.

In an exemplary embodiment, the beverage extraction device may further include: a water container for supplying room temperature water to the first extracting part and the second extracting part, wherein the water container may be provided between the first waste capsule collecting part and the second waste capsule collecting part.

According to an embodiment of the present invention, a beverage extraction device for extracting a beverage using a capsule containing powder may be provided, the device including: a housing configured form an outer appearance and containing powder; an extracting part provided inside the housing and configured to supply hot water to extract the beverage; and a capsule storing box provided on a side surface of the extracting part and configured to store the capsule before use.

According to an embodiment of the present invention, a beverage extraction device for extracting a beverage using a capsule containing powder may be provided, the device including: a housing configured form an outer appearance and containing powder; an extracting part provided inside the housing, provided with a capsule holder configured to hold the capsule and supply hot water into the capsule, and configured to extract the beverage; and a waste capsule collecting part provided below the extracting part and configured to store the waste capsule from which the beverage has been completely extracted and which has been dropped from the capsule holder, wherein the waste capsule collecting part includes a basket storing part provided to rotate to a rear side of the housing, and a basket configured to store the waste capsule from which the beverage has been completely extracted from the extracting part and provided so as to be stored in the basket storing part and be selectively removed from the basket storing part.

According to an embodiment of the present invention, a method for controlling capsule beverage extraction device for extracting a beverage using a capsule comprising powder, includes: determining whether a movement of a user has been detected via a movement detecting sensor; and turning on a boiler when it is determined that a movement of the user has been detected.

In an exemplary embodiment, in the turning on the boiler, the boiler may operate for a predetermined time.

In an exemplary embodiment, the method for controlling capsule beverage extraction device may further include determining whether there is a beverage extraction request within a preset time after turning on the boiler.

In an exemplary embodiment, the method for controlling capsule beverage extraction device may further include: determining whether beverage extraction has been completed, the determining being performed when there is a beverage extraction request within a preset time; and turning off the boiler, the turning off being performed when the beverage extraction has been completed.

In an exemplary embodiment, the method for controlling capsule beverage extraction device may further include turning off the boiler, the turning off being performed when there is no beverage extraction request within the preset time.

In an exemplary embodiment, the movement detecting sensor may be an infrared sensor.

In an exemplary embodiment, the movement detecting sensor may be a camera.

In an exemplary embodiment, the capsule beverage extraction device may include: a housing configured to form an outer appearance; and a front panel provided on the front surface of the housing, wherein the movement detecting sensor may be provided to the front panel.

In an exemplary embodiment, the capsule beverage extraction device may include: a housing configured to form an outer appearance; wherein the movement detecting sensor may be provided to the front panel.

In an exemplary embodiment, the capsule beverage extraction device may include: a water container for supplying room temperature water to the boiler, and the method for controlling capsule beverage extraction device may further include determining whether water supply has been stopped after turning on the boiler.

In an exemplary embodiment, the method for controlling capsule beverage extraction device may further include requesting water supply when the water supply has been stopped.

In an exemplary embodiment, the method for controlling capsule beverage extraction device may further include turning off the boiler when the water supply has been stopped.

In an exemplary embodiment, the capsule beverage extraction device may include: a waste capsule collecting part configured to store the waste capsule from which the beverage has been completely extracted, and the method for controlling capsule beverage extraction device may further include determining whether a space of the waste capsule collecting part is insufficient after turning on the boiler.

In an exemplary embodiment, the method for controlling capsule beverage extraction device may further include requesting waste capsule collection when it is determined that the space of the waste capsule collecting part is insufficient.

In an exemplary embodiment, the capsule beverage extraction device may include a capsule storing box configured to store the capsule before use, and the method for controlling capsule beverage extraction device may further include determining whether the stored capsule inside the capsule storing box has been completely used after turning on the boiler.

In an exemplary embodiment, the method for controlling capsule beverage extraction device may further include requesting capsule provision when the stored capsule inside the capsule storing box has been completely used after turning on the boiler.

In an exemplary embodiment, the capsule beverage extraction device may include a pump configured to supply room temperature water to the boiler; and an extracting part configured to supply hot water heated by the boiler and extract the beverage.

According to an embodiment of the present invention, provided is a method for controlling a capsule beverage extraction device, which extracts a beverage using a capsule containing powder and includes a first extracting part and a second extracting part, the method including: determining whether a movement of a user has been detected through a movement detecting sensor; and turning on a boiler configured to heat water supplied to the first extracting part and the second extracting part when it is determined that a movement of the user is detected.

According to an embodiment of the present invention, provided is a method for controlling capsule beverage extraction device for extracting a beverage using a capsule comprising powder, the method including: determining whether a user approaches within a predetermined distance using a movement detecting sensor; and turning on a boiler when it is determined that a user has approached within the predetermined distance.

### Advantageous Effects

The present invention has an effect of simultaneously extracting two or more types of beverage with a single extraction device.

More specifically, the present invention has an effect of preventing flavors from mixing when simultaneously extracting two cups of beverage.

More specifically, the present invention has an effect of optimizing the arrangement of required components for simultaneously extracting two cups of beverage and enhancing space availability.

The present invention has an effect of prevent extracted beverage jetted from a nozzle from rebounding from the bottom of a cup and flowing out of the cup regardless of the height of the cup.

The present invention has an effect of storing, in an extraction device, a new capsule for extracting a beverage by efficiently disposing each of configurations.

The present invention has an effect of storing, in an extraction device, a new capsule for extracting a beverage by efficiently disposing each of configurations.

The present invention has an effect of storing a completely used waste capsule by efficiently using a space of an extraction device, and guaranteeing cleanliness and convenience in a process of drawing the stored waste capsule out of an extraction device.

The present invention has an effect of reducing a waiting time of a user due to boiler preheating.

In addition, the present invention has an effect of requesting water supply before a user extracts a beverage when a water container is vacant.

In addition, the present invention has an effect of requesting waste capsule collection before a user extracts a beverage when a waste capsule tray is fully filled.

In addition, the present invention has an effect of requesting capsule refill before a user extracts a beverage when a capsule storage box is vacant.

### BRIEF DESCRIPTION OF THE DRAWINGS

FIG. 1 is a perspective view of a capsule beverage extraction device in an embodiment to the present invention;

FIG. 2 is a front view of a capsule beverage extraction device according to an embodiment of the present invention;

FIG. 3 is a perspective view of a state of removing a housing of a capsule beverage extraction device according to an embodiment of the present invention;

FIG. 4 illustrates an use example of a capsule beverage extraction device according to an embodiment of the present invention;

FIG. 5 illustrates another embodiment of a tray module of the capsule beverage extraction device;

FIG. 6 illustrates a state in which a configuration for extracting a beverage is disposed inside a housing in the capsule beverage extraction device;

FIG. 7 illustrates a configuration and a flow passage which are for extracting a beverage in the capsule beverage extraction device;

FIG. 8 illustrates a state, in which a configuration for extracting a beverage in the capsule beverage extraction device, and illustrates a rear view;

FIG. 9 illustrates a capsule storage box and a capsule input opening of the capsule beverage extraction device according to an embodiment of the present invention;

FIG. 10 illustrates a cross-section taken along line A of FIG. 2 and illustrates a state in which a second waste capsule collecting part of the capsule beverage extraction device is open rearward;

FIG. 11 illustrates a cross-section taken along line B of FIG. 2 and illustrates a state in which a second waste capsule collecting part of the capsule beverage extraction device is closed;

FIG. 12 illustrates a state in which a second waste capsule basket is drawn out of a second basket storage part;

FIG. 13 illustrates a state in which one side of the housing is open;

FIG. 14 illustrates the rear surface of the capsule extraction device;

FIG. 15 illustrates a state in which a water container is separated from the capsule extraction device;

FIG. 16 illustrates a flow for detecting a movement of a user and preheating a boiler;

FIG. 17 illustrates a flow for detecting a movement of a user and preheating a boiler, and determining whether to turn on or off the boiler according to presence of extraction request within a preset time;

FIG. 18 illustrates a flow for detecting a movement of a user and preheating a boiler, requesting water supply when water is deficient in the water container, and then turning off the boiler;

FIG. 19 illustrates a flow for detecting a movement of a user and preheating a boiler, requesting collection when a space is deficient in a water capsule collection part, and then turning off the boiler; and

FIG. 20 illustrates a flow for detecting a movement of a user and preheating a boiler, requesting capsule provision when a capsule is completely used in a capsule storing box water, and then turning off the boiler.

### MODE FOR CARRYING OUT THE INVENTION

Hereinafter, various embodiments of the present invention will be described with reference to drawings.

A capsule beverage extraction device according to an embodiment of the present invention is device that jets a high-pressure hot water into a capsule including powder, and is a device that is capable of simultaneously extracting two or more types of beverage tea, coffee, and the like).

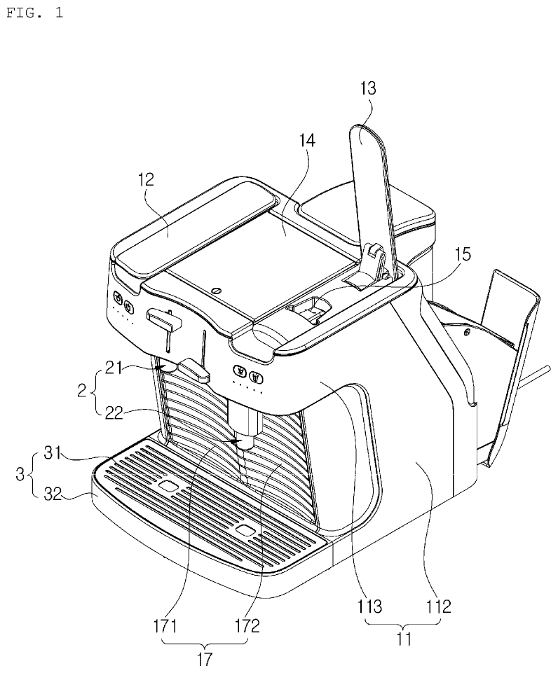

Hereinafter, the external structure of the capsule beverage extraction device will be described with reference to FIG. 1.

A capsule beverage extraction device according to an embodiment of the present invention may include a housing 11 that forms outer appearance, and the housing 11 may include a housing lower part 112 and a housing upper part 113 integrally provided above the housing lower part 112.

In addition, the capsule beverage extraction device may further include a nozzle 2 that protrudes outward from the housing upper part 113 and jets beverage, the nozzle 2 may include a first nozzle 21 and a second nozzle 22, and thus, two or more types of beverage may simultaneously be extracted.

The capsule beverage extraction device may further include a tray module provided below the nozzle and the tray module 3 may be formed by the tray 31 on which a cup is placed and a remaining water support part 32 that is connected to the front surface of the housing 11 and supports the tray 31.

A front panel 17 that supports the rear surface of the cup placed on the tray 31 may be provided on the front surface of the housing lower part 112, and the front panel 17 may include a first panel 171 that supports the rear surface of the cup placed below the nozzle 21 and a second panel 172 that supports the rear surface of the cup placed below the second nozzle 22.

The first panel 171 and the second panel 172 may both be provided to be bent rearward so that the center sections thereof are positioned in rear of both end sections thereof.

In the capsule beverage extraction device, while a boiler and a pump are driven during beverage extraction, vibration is generated in a main body and a cup placed on the tray 31 may deviate outward, and at this point, this problem may be solved by preventing left-right movement of the cup using the front panel 17.

Meanwhile, the capsule beverage extraction device may include a first capsule input opening 16 and a second capsule input opening 15 which are provided on the upper surface of the housing upper part 113, and may further include a first capsule input opening cover 12, which is connected to the housing upper part 113 and selectively opens/closes the first capsule input opening 16, and a second capsule input opening cover 13 that selectively opens/closes the second capsule input opening 15.

In addition, a capsule storage box cover 14 may be provided between the first capsule input opening cover 12 and the second capsule input opening cover 14, and the capsule storage cover 14 may selectively open/close a capsule storage box 4.

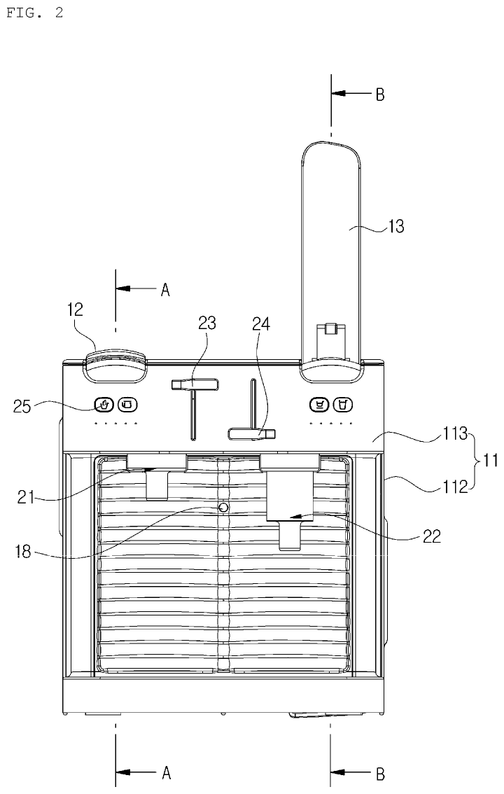

Next, referring to FIG. 2, the first nozzle 21 and the second nozzle 22 may be provided so that the vertical height thereof can be adjusted, and to this end, the capsule beverage extraction device may further include a first nozzle moving handle 23 connected to the first nozzle 21 and a second nozzle moving handle 24 connected to the second nozzle 22.

Accordingly, when a cup having a large height is placed on the tray 31, a user may raise the nozzle using the nozzle moving handle, and when a cup having a small height is placed, the nozzle may be lowered using the nozzle moving handle.

In addition, the capsule beverage extraction device according to an embodiment of the present invention may further include: a button 25 that is provided on the front surface of the housing upper part 113 and generates a boiler preheating signal and a beverage extracting signal by an operation of a user; and a movement detecting sensor 18 that is provided to the front panel 17 and detects a movement of the user.

The movement detecting sensor 18 may be provided to the front surface of the housing upper part 113, but may preferably be provided on the front panel 17 in order to detect a user with a small height.

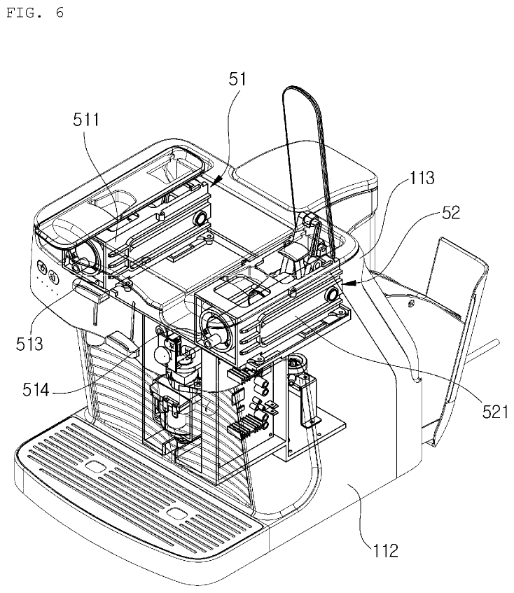

The movement detecting sensor 18 may be provided as an infrared sensor or a camera sensor, and when a movement of a user is detected through the movement detecting sensor 18, the boiler 71 illustrated in FIG. 6 may operate.

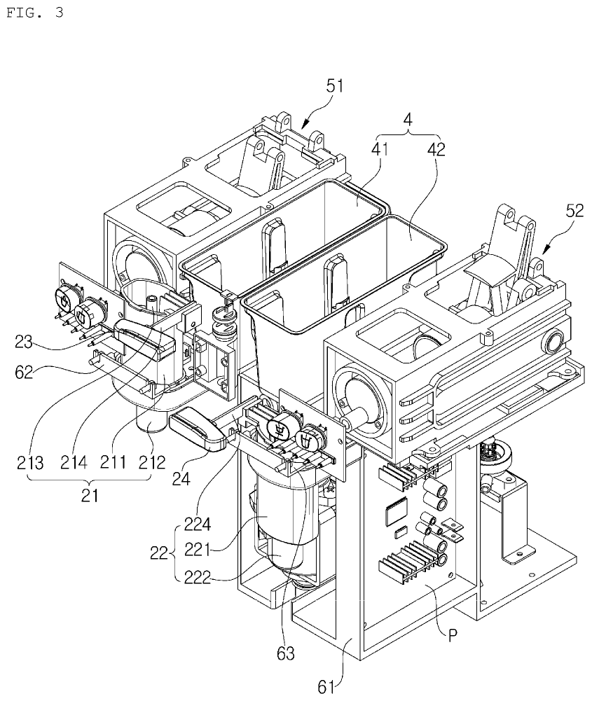

Hereinafter, the detailed structure of the nozzle 2 will be described in more detail with reference to FIG. 3 that illustrates the capsule beverage extraction device from which the housing 11 is removed.

The capsule beverage extraction device may include: a first extracting part 51 that extracts a beverage by jetting a high-pressure hot water to a capsule including powder; and a second extracting part 52 that is provided beside the first extracting part 51 and extracts a beverage by jetting a high-pressure hot water to a capsule including powder.

In addition, the first nozzle 21 may include: a first nozzle housing 211; a first nozzle jet part 212 connected below the first nozzle housing 211; a first nozzle inflow part 213 that communicates with the first extracting part 51 and guides a beverage extract to the first nozzle jet part 212; and a first handle connection part 214 that connects the first nozzle moving handle 23 and the first nozzle housing 211.

Likewise, the second nozzle 22 may include: a second nozzle housing 221; a second nozzle jet part 222 connected below the second nozzle housing 221; a second nozzle inflow part 223 that communicates with the second extracting part 52 and guides a beverage extract to the second nozzle jet part 222; and a second handle connection part 224 that connects the second nozzle moving handle 24 and the second nozzle housing 221.

In addition, the capsule beverage extraction device may further include: an inner frame 61 fixed inside the housing 11; a first nozzle connection part 62 fixed to the front end of the inner frame 61; and a second nozzle connection part 63 fixed to the front end of the inner frame 61 and provided beside the first nozzle connection part 62.

The first nozzle housing 211 may be provided so as to be connected to the first nozzle connection part 62 and vertically movable by passing through the first nozzle connection part 62, and the second nozzle housing 221 may also be provided so as to be connected to the second nozzle connection part 63 and be vertically movable by passing through the second nozzle connection part 63.

In addition, the first extracting part 51 and the second extracting part 52 may be provided above the inner frame 61, and a capsule storage box 4, which is a basket for storing beverage capsule before use, may further be provided between the first extracting part 51 and the second extracting part 52.

The capsule storage box 4 may include a first capsule storage box 41 for storing a capsule to be input to the first extracting part 51; and a second capsule storage box 42 for storing a capsule to be input to the second extracting part 52, and the first capsule storage box 41 and the second capsule storage box 42 may form spaces independent of each other so as to classify and store mutually different beverage capsules (tea, coffee, and the like).

Meanwhile, a PCB P which controls the capsule beverage extraction device may be provided beside the inner frame 61.

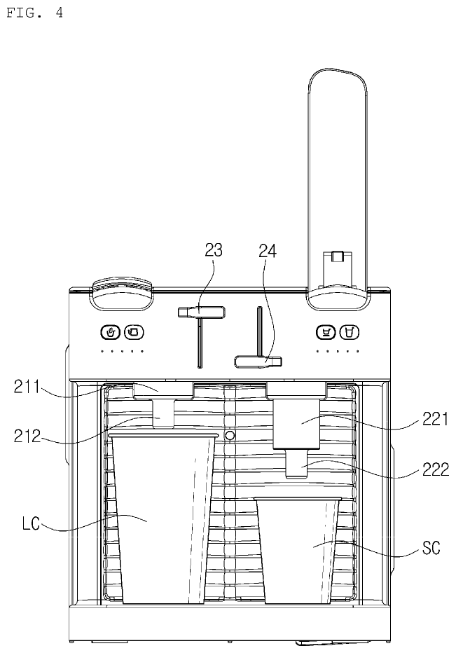

FIG. 4 illustrates, as an example of placing a cup on the tray 31, a state in which a cup LC having a large height is provided under the first nozzle 21 and is used in a state in which the first nozzle jet part 212 is raised, and a cup having a small height is provided below the second nozzle 22 and is used in a state in which the second nozzle jet part 222 is lowered.

Accordingly, in the present invention, when a cup having a large height is used, the cup is easily placed by raising the nozzle, and when a cup having a small height is used, an extract may rebound from the bottom of the cup and be prevented from flowing out of the cup.

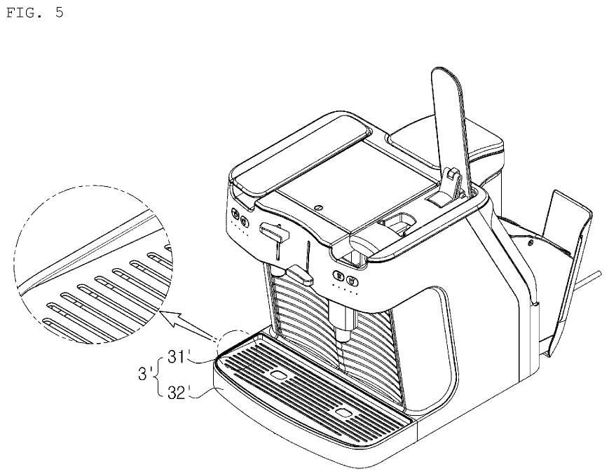

FIG. 5 illustrates another embodiment of a tray module 3′.

Specifically, a tray 31′ may be provided so that the rear end thereof inclines a predetermined angle rearward, and a remaining support part 32′ may also support the tray 31′ so as to maintain a state in which the tray 31′ inclines rearward.

This, together with the bent structure of the front panel 17, functions to effectively prevent a problem in which while the boiler and the pump are operated, vibration occurs in the main body and the cup placed on the tray 31 deviates to the outside.

FIG. 6 illustrates a state of removing the nozzle 2, and the structures of the extracting parts 51 and 52 will be described with reference to FIG. 6.

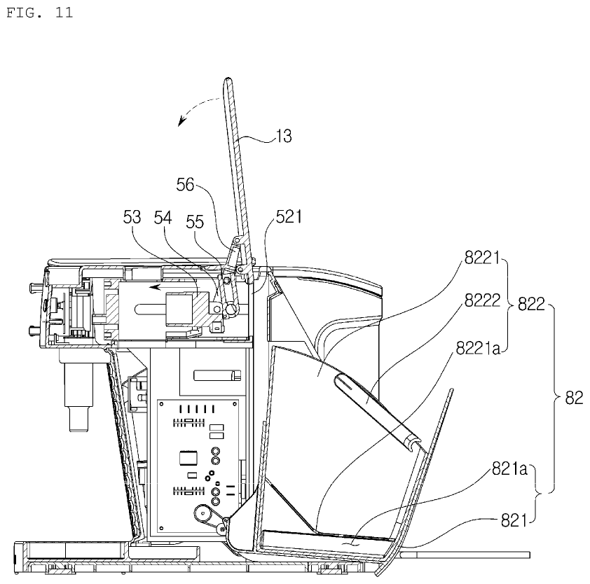

The first extracting part 51 may include a first extracting part frame 511 that accommodates a capsule holder 53 (FIG. 11) which holds the capsules and supplies hot water to the capsule, and the second extracting part 52 may include a second extracting part frame 521 that accommodates a capsule holder 53 (FIG. 11) which is provided side by side with the first extracting part frame, holds the capsules and supplies hot water to the capsule.

In addition, lateral surfaces of the first extracting part frame 511 and the second extracting part frame 521 may be configured as closed surface, and the flavors of beverage extracted from each of the first extracting part frame 511 and the second extracting part frame 521 may not be mixed with each other.

Furthermore, the first extracting part 51 may be provided with a first discharge part 513 for supplying a beverage extract to the first nozzle inflow part 213, and the second first extracting part 52 may be provided with a second discharge part 514 for supplying a beverage extract to the second nozzle inflow part 223.

The first discharge part 513, the first nozzle inflow part 213, and the second nozzle inflow part 223 of the second discharge part 514 may be connected by a hose (not shown) composed of a flexible material.

This functions to prevent flavors from being mixed by maintaining mutually independent flow passages, and to prevent a problem of detachment of a hose.

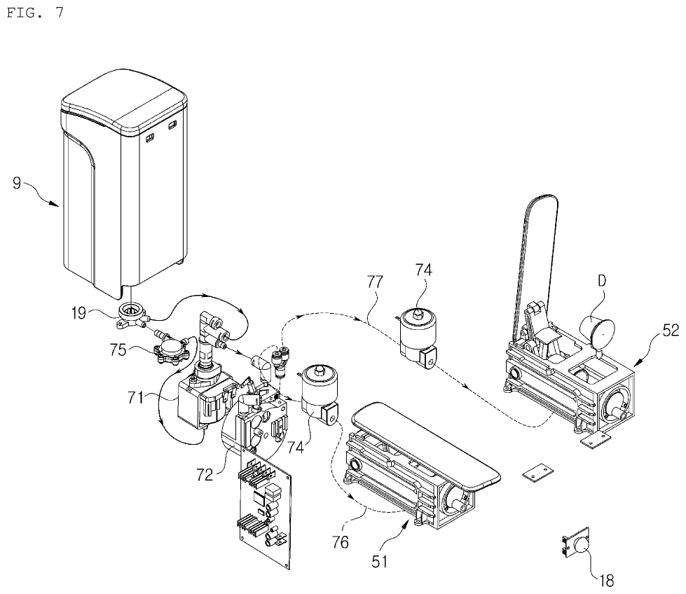

Hereinafter, referring to FIG. 7, configurations for supplying hot water to the extracting part will be described in detail.

In FIG. 7, lines through which room-temperature water flows is represented by solid lines, and lines through which hot water flows is represented by dot lines.

First, the capsule beverage extraction device my include, as portions related to the room-temperature water lines, a water container 9 for storing room-temperature water; a flow adjustment part 19 connected to a discharge part of the water container 9; a flow rate meter 75; a boiler 71 that converts the room-temperature water into hot water; and a pump 72 for supplying power so as to supply the room-temperature water from the water container 9 to the boiler 71.

In addition, the capsule beverage extraction device may include, as portions related to hot water lines, a first flow passage 76 that connects the boiler 71 and the first extracting part 51; a first valve 73 that selectively opens/closes the first flow passage 76; a second flow passage that connects the boiler 71 and the second extracting part 52; and a second valve 74 that selectively opens/closes the second flow passage 77.

Accordingly, in the invention of the present application, hot water may be selectively supplied to each of the two extracting parts with a single boiler and a single pump, and thus, energy efficiency may be enhanced and the total volume of mechanism may be reduced.

Meanwhile, the first valve 73 and the second valve 74 may be provided in any form as long as being capable of opening/closing the first flow passage 76 and the second flow passage 77, but may favorably be provided as solenoid valves.

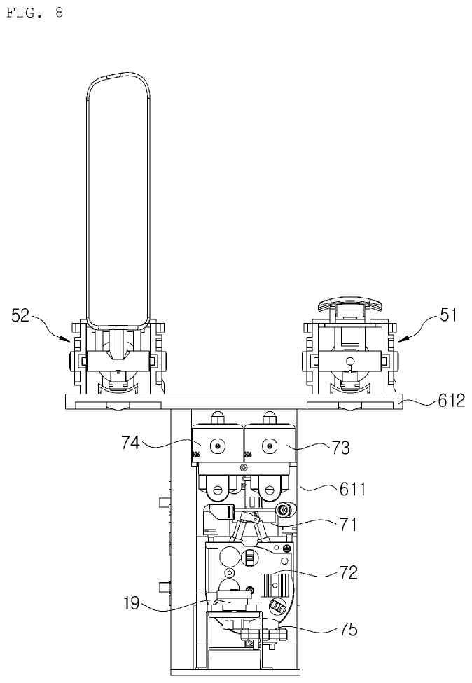

The above configurations may be fixed to the inner frame 61 and an optimal arrangement structure of this will be described hereinafter with reference to FIG. 8.

The inner frame 61 may include a lower inner frame 611 and an upper inner frame 612 provided on the lower inner frame 611.

The flow rate meter 75, the boiler 71, the pump 72, the first valve 73 and the second valve 74 may be provided inside the lower inner frame 611, and a waste capsule collection part may be positioned beside the lower inner frame 611 to be described later.

In addition, the pump 72 may be positioned in rear of the boiler 71, and the first valve 73 and the second valve 74 may be disposed above the boiler 71 and minimize the lengths of the first flow passage 76 and the second flow passage 77.

This has an excellent effect in that spaces may be efficiently used and the pressure of hot water may be increased by reducing flow passage resistance.

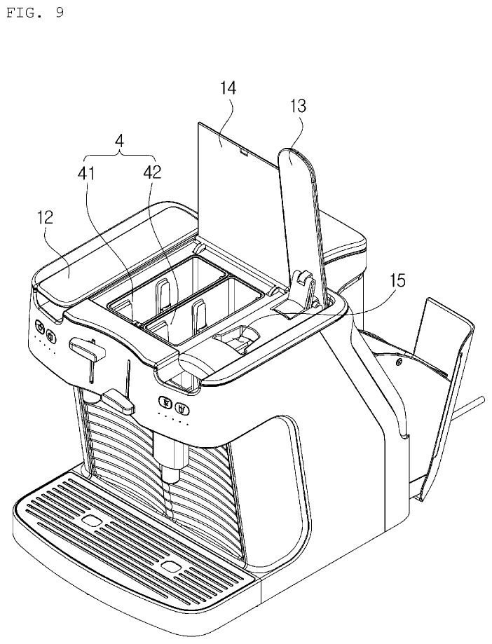

Next, a configuration related to a capsule storage box cover 14 of the capsule beverage extraction device will be described with reference to FIG. 9 that illustrates a state in which the capsule storage cover is open.

As described above, the first capsule storage box 41 and the second capsule storage box 4 may be provided between the first extracting part 51 and the second extracting part, and the capsule storage box cover 14 may be provided between the first capsule input opening cover 12 and the second capsule input opening cover 14.

Accordingly, a user may open the capsule storage box cover 14 and immediately input capsules into capsule openings 15 and 16, so that a capsule input movement line may be minimized and use convenience may be maximized.

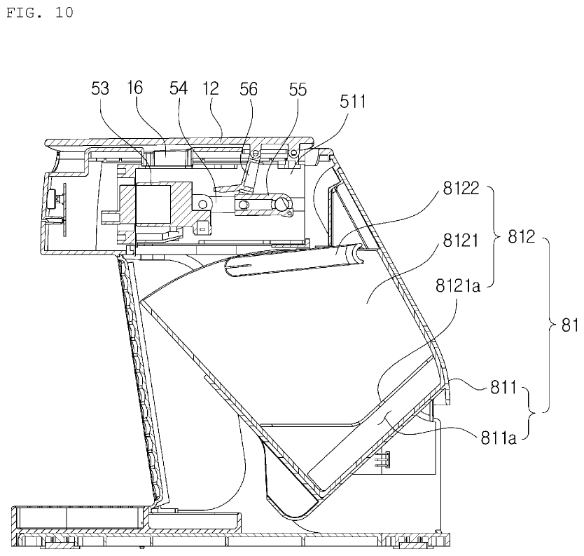

Hereinafter, referring to FIG. 10 that illustrates cross-section A of FIG. 2 and to FIG. 11 that illustrates cross-section B of FIG. 2, the operation method of the extracting parts and movement paths of capsules will be described.

First, the first extracting part 51 may include: a capsule holder 53; a holder linker 54 connected to a rear side of the capsule holder 53; a frame linker 55 that connects the first extracting part frame 511 and the holder linker 54; and a cover linker 56 that connects the first capsule input opening cover 12 and the holder linker 54.

Accordingly, the capsule input into the first capsule input opening 16 may be held by the capsule holder 53 by closing the first capsule input opening cover 12.

The capsule beverage extraction device may further include: waste capsule collecting parts 81 and 82 that are stored inside the housing 11 and provided below the extracting parts 51 and 52; and the waste capsule collecting parts 81 and 82 that store the waste capsules from which the beverage has been completely extracted in the extracting parts 51 and 52.

More specifically, the waste capsule collecting parts 81 and 82 may include a first waste capsule collecting part 81 provided below the first extracting part 51, and the first waste capsule collecting part 81 may include; a first basket storing part 811 provided so as to rotate to the rear side of the housing 11 so that the upper surface thereof is open to the outside; and a first waste capsule basket 812 provided so as to be taken out from the first basket storing part 811 via the upper surface of the first basket storing part 811.

In addition, a lower portion of the capsule holder 53 of the first extracting part 51 in the upper inner frame 612 may be formed as an open surface open toward the first waste capsule collecting part 81 so that the waste capsule from which the beverage has been completely extracted deviates out of the capsule holder 53 and falls to the first waste capsule collecting part 81, and thus, the completely used waste capsule may be naturally loaded on to the first waste capsule collecting part 81.

In addition, the first waste capsule basket 812 may include: a basket body 8121 for storing waste capsules; a basket handle 8122 connected to the upper side of the basket body 8121; and a basket hole 8121a that is provided on the lower surface of the basket body 8121 and discharges remaining water of the waste capsules.

In addition, a remaining water stay space 811a in which remaining water discharged through the basket hole 6121a may be provided in a lower portion of the first basket storing part 811.

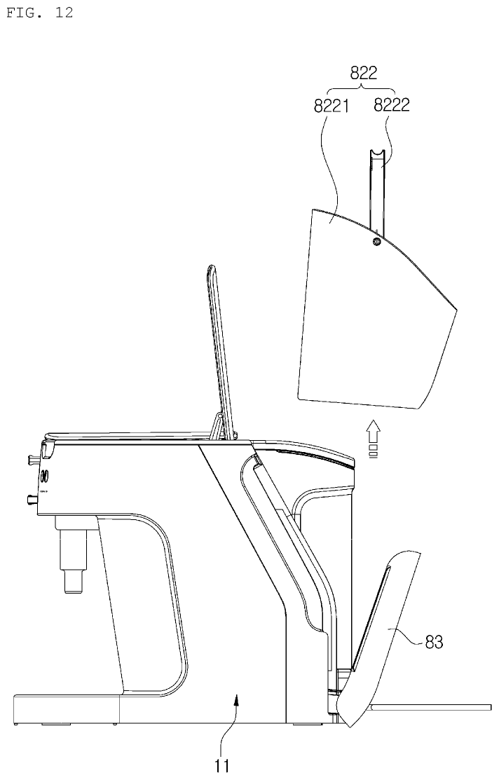

Hereinafter, referring to FIG. 12, a configuration related to the processing route for the capsule input to the second extracting part 52.

Similarly, the second extracting part 52 may include: a capsule holder 53; a holder linker 54 connected to a rear side of the capsule holder 53; a frame linker 55 that connects the second extracting part frame 521 and the holder linker 54; and a cover linker 56 that connects the second capsule input opening cover 12 and the holder linker 54.

Accordingly, the capsule input into the second capsule input opening 16 may be held by the capsule holder 53 by closing the second capsule input opening cover 13.

In addition, the waste capsule collecting parts 81 and 82 may include a second waste capsule collecting part 82 provided below the second extracting part 52, and the second waste capsule collecting part 82 may include; a second basket storing part 821 provided so as to rotate to the rear side of the housing 11 so that the upper surface thereof is open to the outside; and a second waste capsule basket 822 provided so as to be taken out from the first basket storing part 821 via the upper surface of the second basket storing part 821.

In addition, a lower portion of the capsule holder 53 of the second extracting part 52 in the upper inner frame 612 may be formed as an open surface open toward the first waste capsule collecting part 82 so that the waste capsule from which the beverage has been completely extracted deviates out of the capsule holder 53 and falls to the second waste capsule collecting part 82, and thus, the completely used waste capsule may be naturally loaded on to the second waste capsule collecting part 82.

In addition, the second waste capsule basket 822 may include: a basket body 8221 for storing waste capsules; a basket handle 8221 connected to the upper side of the basket body 8221; and a basket hole 8221a that is provided on the lower surface of the basket body 8221 and discharges remaining water of the waste capsules.

In addition, a remaining water stay space 821a in which remaining water discharged through the basket hole 8221a may be provided also in a lower portion of the second basket storing part 821.

FIG. 12 illustrates a state in which the waste capsule baskets 812 and 822 are removed from the basket storing parts 811 and 821, and due to the above configuration, a user may grip the handles 8122 and 8222, lift basket bodies 8121 and 8221 upward, and easily take out the waste capsules.

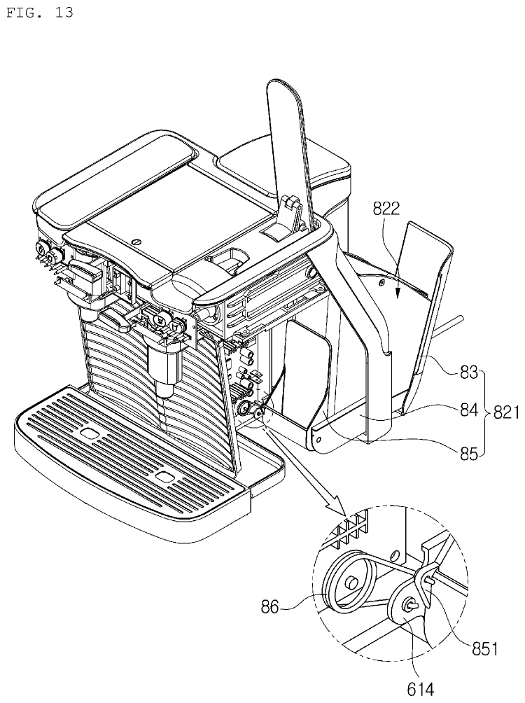

FIG. 13 illustrates a state in which one side of the housing 11 is open, and the connecting structure of the basket storing parts 811 and 821 may be confirmed.

Specifically, the basket storing parts 811 and 821 may include: a front cover 85; a base 84 that forms the remaining water stay space 821a connected to the lower end of the front cover 85; and a rear cover 83 extending upward from the rear end of the base 84.

In addition, an elastic part fastening part 851 is provided to the front cover 85, a storing part connecting part 614 is provided inside the housing 11, and the elastic part fastening part 851 and the storing part connecting part 614 may be connected via an elastic part provided as a torsion spring.

The elastic part 86 may provide an elastic force to the basket storing parts 811 and 812 in a direction toward the inside of the housing, and thus, when the waste capsule baskets 812 and 822 are taken out, the basket storing parts 811 and 821 may automatically be restored in a closed state.

The storing part connecting part 614 may be provided to any one among the inner wall of the housing 11, the inner frame 61, or the PCB P.

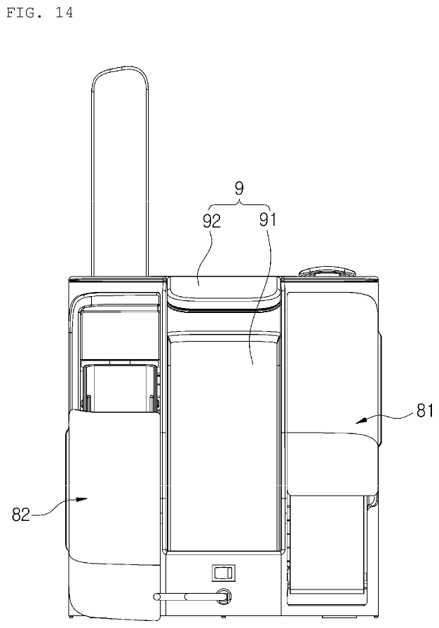

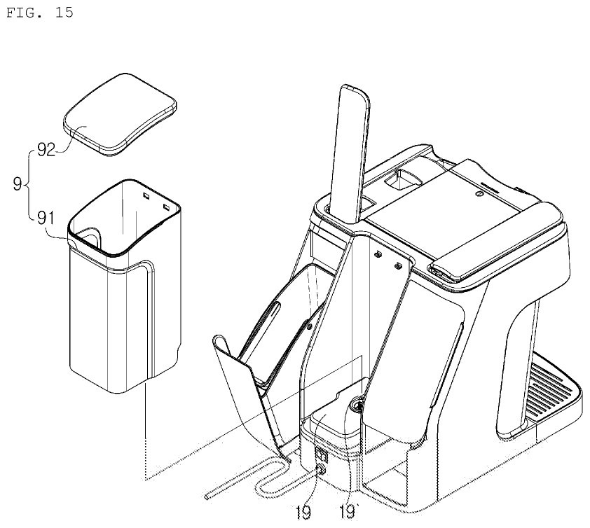

Hereinafter, referring to FIGS. 14 and 15, a rear side structure of the capsule extraction device will be described.

The water container 9 may include a water container body 91 and a water container cover 92, and be provided between the first waste capsule collecting part 81 and the second waste capsule collecting part 82.

In addition, a water container mounting part 19 to which the water container body 91 is mounted may be provided in rear of the housing 11, and the water container body 91 may selectively be mounted on the water container mounting part 19.

Accordingly, the height of the water container may be increased without limitation of an upper space, a water storage capacity may be increased, and the rear space of the capsule beverage extraction device may be efficiently used.

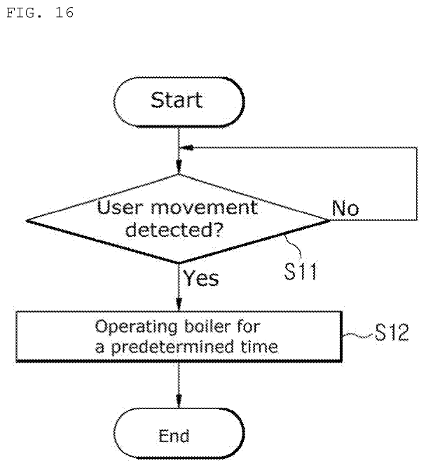

Hereinafter, referring to FIG. 16, a method for controlling a capsule beverage extraction device according to an embodiment of the present invention.

A method for controlling a capsule beverage extraction device may include: a step S11 for determining whether a movement of a user has been detected via a movement detecting sensor 18; and a step S12 for turning on a boiler when it is determined that a movement of the user has been detected.

At this point, the boiler 61 may be turned on during only a predetermined time, and at this point, the predetermined time may be the time during which the user moves to the front side of the capsule beverage extraction device after the movement of the user has been recognized.

Hereinafter, the boiler 61 may continuously operate by an operation of a button 25 by the user, and the remaining heating may be performed.

The movement detecting sensor 18 may be configured as an infrared sensor, and when a user approaches within a predetermined distance (for example, approximately 3-5 meter) and a movement is detected by the infrared sensor, the preheating of the boiler may be started.

In addition, the movement detecting sensor 18 may be configured as a camera, and when a user approaches within a predetermined distance (for example, approximately 3-5 meter) and a movement is detected by the camera, the preheating of the boiler may be started.

Accordingly, since the boiler may start preheating in advance during the time in which the user approaches, an excellent effect may be obtained in which the time for which a user waits in front of the capsule beverage extraction device is reduced.

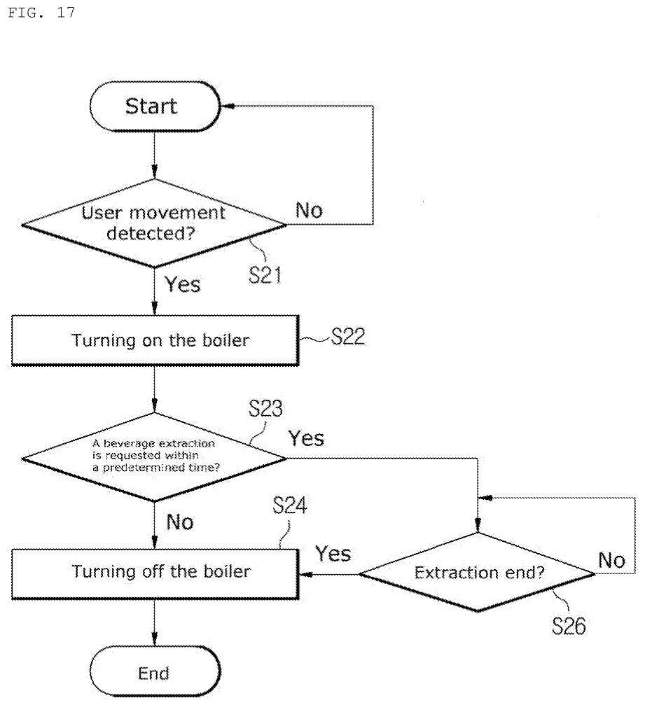

Next, referring to FIG. 17, another embodiment of a method for controlling a capsule beverage extraction device will be described.

As a difference from the above-mentioned embodiment, a method for controlling a capsule beverage extraction device may further include a step S23 for determining whether there is a beverage extraction request within a predetermined time after turning on a boiler.

When it is determined that there is no beverage extraction request within the preset time of step S23 while the on-state of the boiler continues after the step S22 for turning on of the boiler, a step S24 for turning off the boiler may further be performed.

Accordingly, an effect may be obtained in that when a user has an intention to use the capsule beverage extraction device and approaches to the front side of the capsule beverage extraction device, does not immediately operate a button 25 but operates the button after some time, a preheating time may be increased.

Meanwhile, the method for controlling the capsule beverage extraction device may further include a step S26 which is for determining whether beverage extraction is completed and which is performed when it is determined that there is a beverage extraction request within the preset time in step S23.

This corresponds to the case in which the user immediately operates the button 25, and when it is determined that beverage extraction is completed, the step S24 for turning off the boiler may be performed.

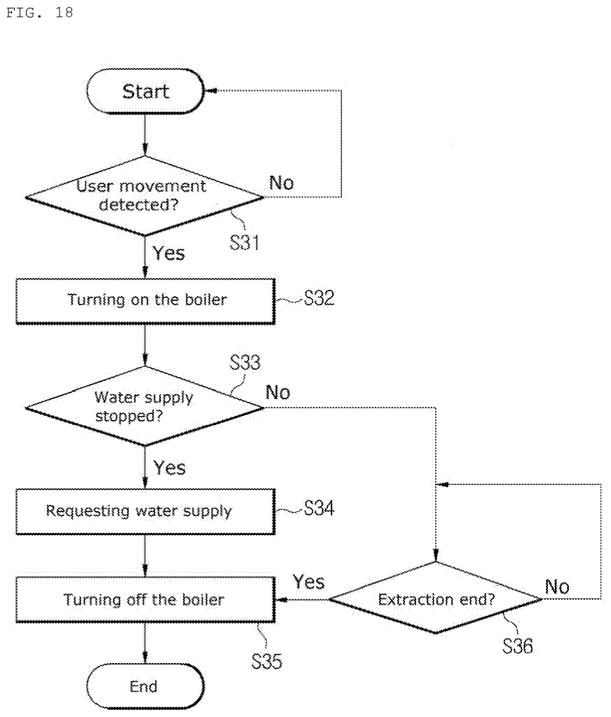

Next, referring to FIG. 18, still another embodiment of a method for controlling a capsule beverage extraction device will be described.

According to the present embodiment, the method for controlling the capsule beverage extraction device may include; a step S33 for determining whether water supply is stopped after turning on the boiler; and a step S34 for requesting water supply when the water supply has been stopped.

In the water supply request step S34, the necessity of water supply to a water container 9 may be informed by warning sound, voice, light, display, or the like.

Accordingly, a user may recognize that a water container is vacant while approaching and thus immediately perform water supply and quickly receive beverage.

Furthermore, when water supply is stopped, the step S35 of turning off the boiler may further be performed, and this is for preventing abnormal operation in which the boiler continuously operates in a water shortage state.

In addition, in the method for controlling the capsule beverage extraction device, a step S36 may be performed, which is performed when it is determined that water supply has not been stopped in the step S33 and which is for determining whether beverage extraction is completed, and here, when it is determined that beverage extraction has been stopped, the step S35 for turning off the boiler may be performed.

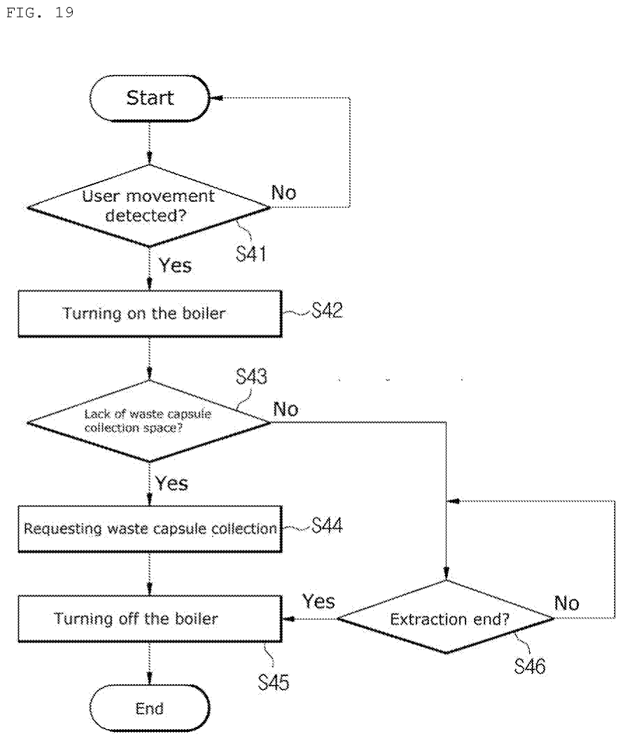

Next, referring to FIG. 19, still another embodiment of a method for controlling a capsule beverage extraction device will be described.

According to the present embodiment, the method for controlling the capsule beverage extraction device may include: a step S43 for determining whether spaces of the waste capsule collecting parts 81 and 82 are insufficient after the boiler has been turned off; and a step S44 for requesting waste capsule collection when it is determined that the spaces for the waste capsule collecting parts are insufficient.

To this end, remaining capacity detecting sensors (not shown) may be provided to the waste capsule collecting parts 81 and 82, and the necessity of waste capsule collection may be informed in the step S44 for requesting waste capsule collection by warning sound, voice, light, display, or the like.

Accordingly, the capsule beverage extraction device may be maintained in a sanitary way, the problem may be solved in which the waste capsule collection parts 81 and 82 are fully filled and the step may not be performed in which beverage is extracted and the capsule falls.

Furthermore, the step S45 for turning off the boiler may further be performed, and this is for preventing abnormal operation in which the boiler continuously operates in a non-use state.

In addition, in the method for controlling the capsule beverage extraction device, a step S36 may be performed, which is performed when it is determined that the space for the waste capsule collecting part is not insufficient and which is for determining whether beverage extraction is completed, and here, when it is determined that beverage extraction has been completed, the step S45 for turning off the boiler may be performed.

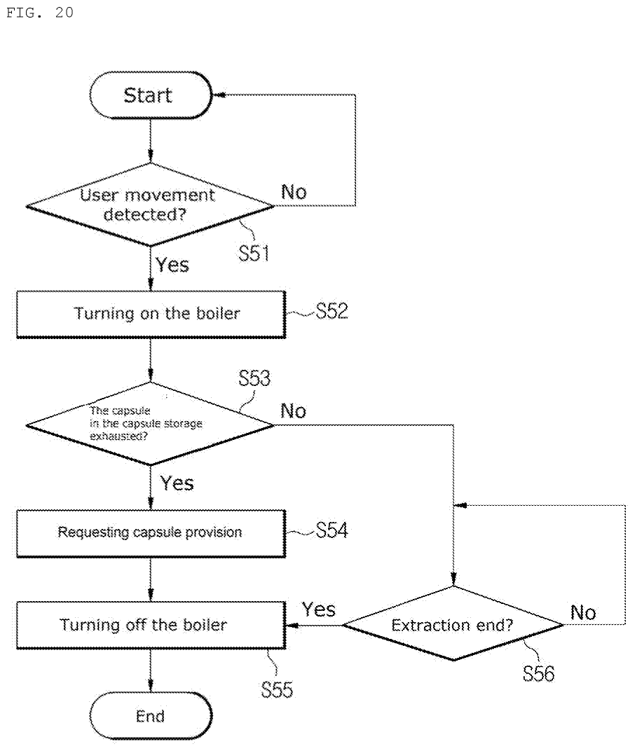

Next, referring to FIG. 20, still another embodiment of a method for controlling a capsule beverage extraction device will be described.

According to the present embodiment, the method for controlling the capsule beverage extraction device may include: a step S53 for whether the stored capsules inside the capsule storing box 4 is completely used after turning on the boiler; and a step S54 for requesting capsule provision when it is determined that the stored capsules inside the capsule storing box has been completely used.

To this end, a capsule check sensor (not shown) may be provided to the capsule storing box 4, and the necessity of capsule provision may be informed in the step S54 for requesting capsule provision by warning sound, voice, light, display, or the like.

Accordingly, a user may check during approach whether a capsule is necessary.

Furthermore, the step S45 for turning off the boiler may further be performed, and this is for preventing abnormal operation in which the boiler continuously operates in a non-use state.

In addition, in the method for controlling the capsule beverage extraction device, a step S56 may be performed, which is performed when it is determined that water supply has not been completely used in the step S53 and which is for determining whether beverage extraction is completed, and here, when it is determined that beverage extraction has been completed, the step S55 for turning off the boiler.

Configurations of the present invention may each have a different effect even though the effect is not described in this specification, and a new effect that was not available in typical arts may be derived according to organic combination relationship between the configurations.

In addition, embodiments illustrated in the drawings may be modified and implemented in different forms, and when the embodiments are implemented including configurations claimed in claims of the present invention or implemented within equivalent ranges, it should be construed to be within the scope of the present invention.

### DESCRIPTION OF SYMBOLS

Housing 11 Nozzle 2 Tray module 3 Capsule storage box 4 Extracting part 5 Inner frame 6

1. A capsule beverage extraction device, for extracting a beverage using a capsule comprising powder, comprises:
a pump configured to supply room temperature water;
a boiler configured to heat the room temperature water supplied from the pump and convert the room temperature water into hot water;
a first extracting part configured to supply hot water to a capsule and extract the beverage;
a second extracting part provided beside the first extracting part and configured to supply hot water to the capsule and extract the beverage;
a first flow passage configured to supply hot water to the first extracting part from the boiler;
a first valve configured to selectively open/close the first flow passage;
a second flow passage configured to supply hot water from the boiler to the second extracting part; and
a second valve configured to selectively open/close the second flow passage.

2. The capsule beverage extraction device of claim 1, wherein:
the first extracting part comprises a first extracting part frame configured to store a capsule holder for holding the capsule and supplying hot water to the capsule;
the second extracting part comprises a second extracting part frame provided side by side with the first extracting part frame and configured to store a capsule holder for to holding a capsule and supplying hot water to the capsule; wherein:
one side surface of the first extracting part frame is formed as a closed surface; and
one side surface of the second extracting part frame in the first extracting part direction directing the one side surface of the first extracting part frame is formed as a closed surface.

3. The capsule beverage extraction device of claim 1, further comprising:
a housing constituting exterior appearance; and
an inner frame provided inside the housing.

4. The capsule beverage extraction device of claim 3, wherein the inner frame comprises:
a lower inner frame configured to store the pump and the boiler; and
an upper frame to which the first extracting part and the second extracting part are fixed.

5. The capsule beverage extraction device of claim 4, further comprising:
a first waste capsule collecting part provided below the first extracting part and configured to store a waste capsule from which the beverage has been completely extracted in the first extracting part; and
a second waste capsule collecting part provided below the second extracting part and configured to store a waste capsule from which the beverage has been completely extracted in the second extracting part, wherein the first waste capsule collecting part and the second waste capsule collecting part are respectively provided on both sides of the lower inner frame.

6. The capsule beverage extraction device of claim 5, further comprising a water container for supplying room temperature water to the pump,
wherein the water container is provided between the first waste capsule collecting part and the second waste capsule collecting part and is positioned in rear of the pump and the boiler.

7. The capsule beverage extraction device of claim 4, further comprising a capsule storing box fixed to the upper inner frame and configured to store the capsule before use,
wherein the capsule storing box is provided between the first extracting part and the second extracting part.

8. The capsule beverage extraction device of claim 7, further comprising a capsule storing box cover provided on an upper surface of the housing and provided so as to selectively open/close the capsule storing box.

9. The capsule beverage extraction device of claim 4, wherein the first valve and the second valve are stored inside the lower inner frame.

10. The capsule beverage extraction device of claim 1, further comprising:
a first nozzle configured to guide, to the outside, the beverage extracted from the first extracting part; and
a second nozzle configured to guide, to the outside, the beverage extracted from the second extracting part,
wherein the first nozzle and the second nozzle are provided so as to have adjustable heights.

11. The capsule beverage extraction device of claim 10, further comprising:
a first nozzle moving handle connected to the first nozzle; and
a second nozzle moving handle connected to the second nozzle.

12. The capsule beverage extraction device of claim 11, further comprising a tray module comprising:
a tray provided below the first nozzle and the second nozzle; and
a remaining water support part provided so as to support the tray,
wherein the tray is supported by the remaining water support part so that a rear end of the tray inclines rearward by a predetermined angle.

13. The capsule beverage extraction device of claim 12, further comprising a front panel provided on a front surface of the housing and configured to support a rear surface of a cup placed on the tray, wherein the front panel comprises:
a first panel provided so as to be bent rearward; and
a second panel provided on a side surface of the first panel and provided so as to be bent rearward.

14. A capsule beverage extraction device, for extracting a beverage using a capsule comprising powder, comprising:
a first extracting part configured to supply hot water to the capsule and extract the beverage;
a second extracting part configured to supply hot water to the capsule and extract the beverage;
a first nozzle configured to guide, to the outside, the beverage extracted from the first extracting part; and
a second nozzle configured to guide the beverage extracted from the second extracting part, wherein
the first nozzle and the second nozzle are provided to have adjustable heights.

15. (canceled)

16. A method for controlling capsule beverage extraction device for extracting a beverage using a capsule comprising powder, the method comprising:
determining whether a movement of a user has been detected via a movement detecting sensor; and
turning on a boiler when it is determined that a movement of the user has been detected.

17. The method of claim 16, wherein in the turning on the boiler, the boiler operates only for a predetermined time.

18. The method of claim 16, further comprising determining whether there is a beverage extraction request within a preset time after turning on the boiler.

19. The method of claim 18, further comprising:
determining whether beverage extraction has been completed, the determining being performed when there is a beverage extraction request within a preset time; and
turning off the boiler, the turning off being performed when the beverage extraction has been completed.

20. The method of claim 18, further comprising turning off the boiler, the turning off being performed when there is no beverage extraction request within the preset time.
